(19) United States
(12) Patent Application Publication
(10) Pub. No.: US 2026/0116409 A1
(43) Pub. Date: Apr. 30, 2026

(54) VEHICULAR DRIVER MONITORING SYSTEM WITH DRIVING QUALITY DETECTION

(71) Applicant: Magna Electronics Inc., Auburn Hills, MI (US)

(72) Inventor: Naresh Ravuri, Novi, MI (US)

(21) Appl. No.: 19/370,174

(22) Filed: Oct. 27, 2025

Related U.S. Application Data
(60) Provisional application No. 63/714,393, filed on Oct. 31, 2024.

(51) Int. Cl. B60W 50/12; B60W 30/16; G06V 20/56; G06V 20/59; H04N 7/18

(52) U.S. Cl. CPC B60W 50/12; B60W 30/162; G06V 20/597; H04N 7/183; B60W 2420/403; B60W 2540/22; B60W 2540/221; B60W 2540/229; B60W 2540/30; B60W 2554/4049; B60W 2555/60; G06V 20/588

(57) ABSTRACT

A vehicular driver monitoring system includes a sensor disposed at a vehicle equipped with the vehicular driver monitoring system. The vehicular driver monitoring system is operable to determine whether a driver of the vehicle is a restricted river. The vehicular driver monitoring system, responsive to determining that the driver is a restricted driver, enables a restricted driver mode. The vehicular driver monitoring system, while the restricted driver is driving the vehicle and while the vehicular driver monitoring system is operated in the restricted driver mode, determines whether the restricted driver performs at least one driving event of a plurality of predefined driving events. The vehicular driver monitoring system, while operating in the restricted driver mode, determines a driving quality score of the restricted driver based on the determined at least one driving event

### CROSS REFERENCE TO RELATED APPLICATION

The present application claims the filing benefits of U.S. provisional application Ser. No. 63/714,393, filed Oct. 31, 2024, which is hereby incorporated herein by reference in its entirety.

### FIELD OF THE INVENTION

The present invention relates generally to a vehicular driver monitoring system for a vehicle and, more particularly, to a vehicular driver monitoring system that utilizes one or more sensors at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driver monitoring system includes a sensor disposed at a vehicle equipped with the vehicular driver monitoring system and sensing exterior of the equipped vehicle. The sensor is operable to capture sensor data. An electronic control unit (ECU) includes electronic circuitry and associated software. Sensor data captured by the sensor is transferred to the ECU. The electronic circuitry of the ECU includes a data processor operable to process sensor data captured by the sensor and transferred to the ECU. The vehicular driver monitoring system is operable to determine whether a driver of the vehicle is a restricted driver. The vehicular driver monitoring system, responsive to determining that the driver is a restricted driver, enables a restricted driver mode. While the restricted driver is driving the vehicle and while the vehicular driver monitoring system is operating in the restricted driver mode, and at least in part via processing at the ECU of captured sensor data, the vehicular driver monitoring system determines whether the restricted driver performs at least one driving event of a plurality of predefined driving events. The vehicular driver monitoring system, while operating in the restricted driver mode, determines a driving quality score of the restricted driver based at least in part on the determined at least one driving event.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras and radar sensors; and

FIG. 2 is a perspective view of an interior rearview mirror assembly, showing an interior-viewing camera.

### DESCRIPTION OF THE PREFERRED EMBODIMENTS

A vehicle vision system and/or driver or driving assist system and/or object detection system and/or alert system and/or vehicular driver monitoring system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

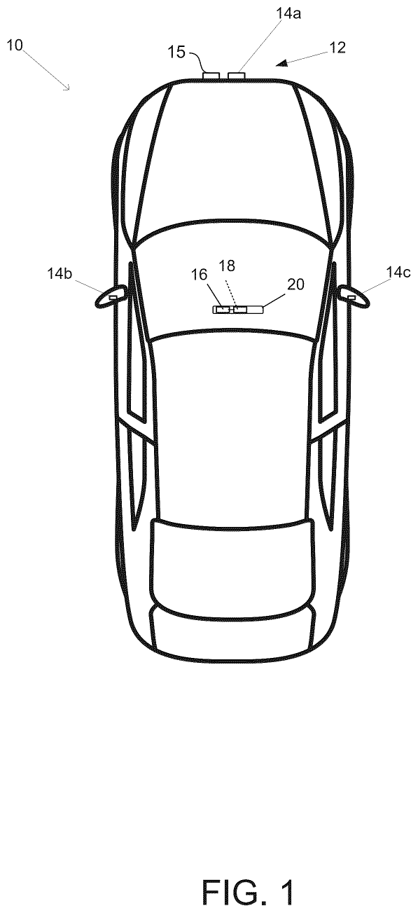

Referring now to the drawings and the illustrative embodiments depicted therein, a vehicle 10 includes an imaging system or sensing system 12 that includes at least one exterior viewing imaging sensor or camera, such as a rear backup camera or rearward viewing imaging sensor or camera (and the system may optionally include multiple exterior viewing imaging sensors or cameras, such as a forward viewing camera 14a at the front (or at the windshield) of the vehicle 10, and a sideward/rearward viewing camera 14b, 14c at respective sides of the vehicle 10), which captures images exterior of the vehicle 10, with the camera having a lens for focusing images at or onto an imaging array or imaging plane or imager of the camera (FIG. 1). The system 12 may also include other sensors, such as one or more radar sensors 15, lidar sensors, ultrasonic sensors, etc. Optionally, a forward viewing camera may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). The system 12 includes a control or electronic control unit (ECU) 18 having electronic circuitry and associated software, with the electronic circuitry including a data processor or image processor that is operable to process image data captured by the camera or cameras, whereby the ECU 18 may detect or determine presence of objects or the like and/or the system provide displayed images at a display device 16 for viewing by the driver of the vehicle 10 (although shown in FIG. 1 as being part of or incorporated in or at an interior rearview mirror assembly 20 of the vehicle 10, the control and/or the display device may be disposed elsewhere at or in the vehicle 10). The data transfer or signal communication from the camera to the ECU 18 may comprise any suitable data or communication link, such as a vehicle network bus or the like of the equipped vehicle 10.

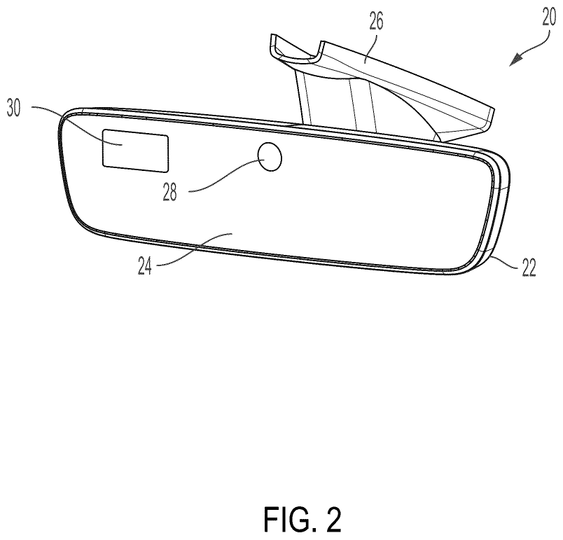

FIG. 2 illustrates an exemplary interior rearview mirror assembly 20 of the equipped vehicle 10. The interior rearview mirror assembly 20 includes a casing 22 and a reflective element 24 positioned at a front portion of the casing 22 (FIG. 1). In the illustrated embodiment, the mirror assembly 20 is configured to be adjustably mounted to an interior portion of a vehicle (such as to an interior or in-cabin surface of a vehicle windshield or a headliner of a vehicle or the like) via a mounting structure or mounting configuration or assembly or stay 26. The system includes an interior-viewing camera 28 disposed at and movable with the mirror head. For example, the camera 28 may be disposed behind the mirror reflective element 24 and view through the mirror reflective element 24 for capturing image data representative of the interior cabin of the vehicle, including the driver's head region and occupant region of the vehicle cabin. The system may utilize aspects of driver monitoring systems or occupant monitoring systems described in U.S. Pat. Nos. 11,930,264; 11,827,153; 11,780,372 and/or 11,639,134 and/or International Publication No. WO 2023/220222, which are all hereby incorporated herein by reference in their entireties. The mirror assembly 20 may include one or more infrared (IR) or near-infrared (NIR) light emitter(s) 30 that, when electrically powered to emit light, emit near-infrared light that passes through the reflective element 24 to illuminate the head region of the driver and/or passengers of the vehicle.

Many modern vehicles include driver-specific vehicle settings. A vehicle may store (e.g., at memory disposed locally at the vehicle and/or at a remote location such as a user device or remote server in communication with the vehicle) profiles of one or more potential drivers of the vehicle. Based on the profile, the vehicle may change a seat position of a seat of the vehicle, adjust mirror positions, and even select a driving mode (e.g., sport mode, winter mode, comfort mode, economy mode, electric mode, etc.) of the vehicle when an occupant associated with the profile is identified.

Implementations herein include a vehicular driver monitoring system that may monitor the cabin of the vehicle to identify or classify a driver of the vehicle, such as, for example, by determining an age or identity of a driver of the vehicle. For example, the vehicular driver monitoring system may identify the driver as an underage driver (i.e., an age less than the legal age for operating the vehicle or otherwise below a threshold age) based on an associated profile or determine the age of the driver based on facial identification using the interior-viewing camera 28 of the vehicle. Alternatively or additionally, the vehicular driver monitoring system may identify the driver based on a key fob associated with the driver who has been previously identified or classified as an underage driver (i.e., student driver, learning driver, or restricted driver). For example, the vehicular driver monitoring system may identify the driver responsive to the vehicle detecting a key fob that the owner identified as being used by the underage or restricted driver. Alternatively or additionally, the vehicular driver monitoring system may identify the driver based on a mobile device associated with the driver when the mobile device connects with the vehicle via, for example, BLUETOOTH or a USB connection. The vehicular driver monitoring system may determine or identify the restricted driver by requiring the driver of the vehicle to identify themselves by signing into a driver account programmed into the vehicle, by voice recognition, fingerprint, facial recognition (or any other biometric signatures), etc.

The restricted driver may be a driver who is under a threshold age (e.g., under the age of 16, under the age of 18, under the age of 21, etc.) and/or is under a legally defined age of majority for the location of the vehicle. Alternatively or additionally, the vehicular driver monitoring system may determine that the driver is otherwise subject to probation or regulation. Upon identifying or determining that the driver of the vehicle is a restricted driver, the vehicular driver monitoring system may activate a student driver mode (i.e., learning driver mode), such as a student driver mode utilizing aspects of the systems described in U.S. Publication No. US-2024-0001950, which is hereby incorporated by reference in its entirety. Optionally, the vehicular driver monitoring system, upon determining that the driver is a restricted driver, prevents the driver from certain functions of the vehicle, such as activating a driving mode of the vehicle (e.g., a sport mode), infotainment restrictions, speed restrictions, etc. The vehicular driver monitoring system may be selectively operable in a parent control mode (i.e., a restricted driver mode). An owner, user, or driver of the vehicle (hereby referred to as “owner”), such as a parent of a restricted driver, may enable parent control mode via a parent control mode interface. For example, the owner may enable parent control mode through a mobile phone application designed for remotely interfacing with the vehicle. Alternatively or additionally, the owner may enable parent control mode through a human machine interface (HMI) of the vehicle, such as an infotainment system of the vehicle or a display of the vehicle. Once the parent control mode is enabled, the owner may enable the student driver mode via the parent control mode. Through the parent control mode, the owner has full control over various driving functions. For example, the owner may determine or set a maximum speed and/or a maximum throttle position or pedal position that the vehicle cannot exceed while the parent control mode is enabled. Optionally, the parent control mode allows the owner to control other aspects of the vehicle. For example, the owner may set a maximum radio volume, prevent the driver from using certain applications on either the infotainment system of the vehicle or the driver's mobile device, or prevent the driver from activating a driving mode of the vehicle, such as sport mode. The vehicular driver monitoring system, when operating in the parent control mode, may maintain a driving quality score for the driver that reflects, e.g., driver attentiveness and safety of driving performance of the driver. The vehicular driver monitoring system may determine the driving quality score based on input from a vehicular control system of the vehicle, and/or sensor data captured by the sensors of the vehicle (e.g., cameras, radar sensors, lidar sensors, ultrasonic sensors, etc.).

The vehicular driver monitoring system may use the interior-viewing camera 28 to determine attentiveness of the driver, such as to determine whether the driver is drowsy or distracted. In other words, the vehicular driver monitoring system may determine whether the driver is likely to fall asleep while driving the vehicle or is not paying sufficient attention to the road (e.g., texting, interacting with the infotainment system, interacting with passengers of the vehicle etc.). The vehicular driver monitoring system may, based on image data captured by the interior-facing camera of the driver's face and eyes, determine the drowsiness or attentiveness of the driver. Facial and ocular indications of drowsiness may include partially closed eyes, fully closed eyes, slow opening and closing of the eyelids, gradual downward nodding of the head, sudden upward jerking of the head, a lack of head movement, a lack of eye movement, etc. Similarly, the vehicular driver monitoring system may determine, based on head, face, or eye movements of the driver, whether the driver is distracted while driving. Indications of distraction may include the driver's head prolongedly or repeatedly facing passengers of the vehicle, prolonged durations of the driver's head or eyes diverting from the road or mirrors of the vehicle, etc. The parent control mode may send a notification to the owner that the driver is drowsy or distracted while driving the vehicle. The vehicular driver monitoring system, when operating in the parent control mode, may adjust the driving quality score based on the level of drowsiness or distractedness.

The vehicular driver monitoring system, when operating in the parent control mode, may determine the driving quality score at the end of a driving cycle of the vehicle. A driving cycle may be defined by a key or ignition cycle of the vehicle, such as turning the vehicle on and subsequently turning the vehicle off, or by a driver's completion of a route, such as the completion of driving to a destination identified by the driver of the vehicle using the display or a mobile app. Additionally or alternatively, the driving cycle may be defined by a segment of driving, such as upon the completion of navigating a segment of a road, a segment of a highway, or a portion of a route. Optionally, the driving cycle may be defined by a preset distance the vehicle has traveled (e.g., one mile, five miles, ten miles, etc.) or a preset amount of time driving (e.g., one minute, five minutes, ten minutes, etc.).

Upon completion of a driving cycle by a human driver, such as a driving cycle completed other than by an autonomous driving system or a driving cycle excluding any portions of the driving cycle performed by an advanced driver assistance system (ADAS), the vehicular driver monitoring system, when operating in the parent control mode, may score the driver's performance (i.e., determine a driving quality score). Optionally, the parent control mode provides a notification through the mobile phone application to the owner of the vehicle that states the driving quality score or other information regarding driving conditions, maneuvers, or events that occurred during the driving cycle.

The vehicular driver monitoring system, when operating in the parent control mode, may determine the driving quality score based at least in part on a count of driving violations that occur during the driving cycle. The driving violations may be determined based on sensor data captured by sensors disposed at the vehicle and/or by using vehicle components. For example, the parent control mode may determine a driving violation upon the vehicular control system of the vehicle determining a lane departure warning. A lane departure warning may occur when the vehicle control system determines, based on image data captured by a forward viewing camera of the vehicle, lane markings of a lane in which the vehicle is traveling along a road. The lane departure warning alerts the driver when the vehicle drifts outside of the lane markings without the driver activating a turn signal of the vehicle. Optionally, the parent control mode may reduce the driving quality score for the driver when the vehicular control system determines a lane departure warning.

The vehicular driver monitoring system, when operating in the parent control mode, may reduce the driving quality score when the driver performs a lane change without activating the turn signal (i.e., a non-indicator lane change). In one example, the vehicular control system may determine the non-indicator lane change based on image data captured by a camera of the vehicle indicating that the vehicle has changed lanes without the driver activating the turn signal. The vehicular control system may determine the lane change based on other systems of the vehicle and/or vehicle dynamics of the vehicle, such as a navigation system of the vehicle, steering wheel position, steering system angle, or a yaw rate of the vehicle. Upon receiving the non-indicator lane change determination of the vehicular control system, the vehicular driver monitoring system may reduce the driving quality score.

The vehicular driver monitoring system, when operating in the parent control mode, may reduce the driving quality score responsive to the vehicular control system determining that the driver is following a leading vehicle at an unsafe following distance (i.e., tailgating). For example, the vehicular control system may determine, based on data captured by a sensor of the equipped vehicle, that a leading vehicle is ahead of the equipped vehicle. The vehicular driver monitoring system may determine, based on the vehicular control system's determination of a velocity of the equipped vehicle and a determined gap between the leading vehicle and the equipped vehicle, that the driver of the equipped vehicle is following the leading vehicle at an unsafe following distance. The sensor may be a radar, lidar, camera, another sensor, or any combination of sensors with which the vehicular control system may determine the distance between the leading vehicle and the equipped vehicle.

The vehicular driver monitoring system may receive a determined speed of the vehicle from a vehicular control system and/or a transmission and/or any sensor of the vehicle (e.g., wheel speed sensor or the like). The vehicular driver monitoring system may use the speed determination to determine driving behavior and/or identify instances of high-speed driving. Alternatively, the vehicular control system may determine a speed of the vehicle based on a speedometer value. Optionally, the vehicular driver monitoring system, when operating in the parent control mode, reduces the driving quality score based on a determined instance of high-speed driving. High-speed driving may include instances where the vehicle is traveling at a speed greater than a posted speed limit of a road on which the vehicle is traveling and/or instances where the vehicle is traveling above a predetermined speed. For example, the owner may, via the parent control mode interface, set the vehicular driver monitoring system to reduce the driving quality score when the speed of the vehicle exceeds, e.g., 65 miles per hour (mph), regardless of whether 65 mph is greater than the posted speed limit of the road on which the vehicle is traveling.

The driving quality score may be reduced responsive to the vehicular control system determining that the driver performed an erratic or risky driving maneuver. In one example, the vehicular driver monitoring system may decrease the driving quality score based on the driver exceeding a threshold speed. For example, the driving quality score may be reduced if the driver exceeds a traffic speed limit or a predefined speed limit (e.g., defined by the owner during configuration of the parent control mode) by 1 mile per hour (MPH), 5 MPH, 10 MPH, etc. The owner may set the threshold speed via the parent control mode interface. The vehicular driver monitoring system may determine the applicable speed limit based on GPS information and map information including a traffic speed limit associated with a road along which the vehicle is traveling. Optionally, the vehicular driver monitoring system may determine the current speed limit based on processing image data captured by a camera of the vehicle. By comparing the traffic speed limit with the speed of the vehicle determined by the vehicular control system, the vehicular driver monitoring system may determine whether the vehicle is exceeding the traffic speed limit.

In another example, the vehicular driver monitoring system, when operating in the parent control mode, may reduce the driving quality score based on a rapid acceleration of the vehicle. The vehicular control system may determine the rapid acceleration based on a throttle and/or pedal position of the vehicle and/or the transmission and/or steering angle of the vehicle. For example, the vehicular control system may determine the rapid acceleration based on the throttle position of 75% throttle or 100% throttle (i.e., wide open throttle). Alternatively, the vehicular control system may determine the rapid acceleration based on a measured longitudinal or lateral acceleration of the vehicle captured by an accelerometer of the vehicle or based on a determined rate of change in velocity. For example, the vehicular control system may determine the rapid acceleration based on a measured longitudinal or lateral acceleration within the range of 0.2 g (i.e., 0.2 gravities) of acceleration, 0.3 g of acceleration, 0.5 g of acceleration, etc.

In still another example, the vehicular driver monitoring system may reduce the driving quality score based on a rapid deceleration of the vehicle. The vehicular control system may determine the rapid deceleration based on an applied brake pressure of a braking system of the equipped vehicle. Alternatively, the rapid deceleration may be determined based on an accelerometer of the vehicle or a determined rate of change in velocity. For example, the vehicular control system may determine the rapid deceleration based on a measured longitudinal deceleration of 0.3 g of deceleration, 0.5 g of deceleration, 0.75 g of deceleration, 1.0 g of deceleration, etc.

The vehicular driver monitoring system, when operating in the parent control mode, may determine erratic steering inputs or failure modes of the steering system. For example, the steering system and/or vehicle control system can determine erratic or aggressive steering maneuvers, which may indicate risky driving behavior or potential steering system failure. The vehicular control system may determine an erratic steering input based on the speed of the vehicle and the position of the steering wheel or the steering angle of the vehicle. Alternatively, the vehicular control system may determine the erratic steering maneuver based on a rate of change of the steering position of the vehicle, or a rate of change of the trajectory of the vehicle. Similarly, the vehicular driver monitoring system may reduce the driving quality score based on a yaw rate of the vehicle determined by the vehicular control system, the yaw rate indicating a rapid turning maneuver. Optionally, the vehicular control system determines the yaw rate using the accelerometer. For example, the vehicular control system may determine a rapid turning maneuver based on a measured lateral acceleration of 0.5 g of lateral acceleration, 0.75 g of lateral acceleration, 1.0 g of lateral acceleration, etc.

For potential erratic driving maneuvers for which the vehicular driver monitoring system may reduce the driving quality score, the owner of the vehicle may determine which driving maneuvers constitute erratic driving maneuvers for the purpose of determining the driving quality score. For example, the owner may, at the parent control mode interface, determine that the vehicular driver monitoring system will reduce the driving quality score if the driver performs an acceleration of over 60% throttle, a deceleration of over 0.7 g, and/or a turning maneuver of over 0.5 g. In another example, the owner may, at the parent control mode interface, determine that the vehicular driver monitoring system will reduce the driving quality score if the driver performs an acceleration of over 80% throttle, a deceleration of over 0.6 g, and/or a turning maneuver of over 0.6 g.

The vehicular driver monitoring system, when operating in the parent control mode, may increase the driving quality score responsive to the vehicular control system determining that the driver performed a driving maneuver that the vehicular driver monitoring system determines is indicative of responsible driving behavior. In one example, the vehicular driver monitoring system may increase the driving quality score based on the driver not exceeding a threshold speed over an interval of time. For example, the vehicular driver monitoring system may increase the driving quality score if the driver does not exceed the speed limit for 5 minutes. Alternatively, the vehicular driver monitoring system may increase the driving quality score if the driver does not exceed the speed limit for a driving cycle.

In another example, the vehicular driver monitoring system may increase the driving quality score based on an acceleration of the vehicle that is less than a threshold acceleration value. For example, the vehicular control system may determine that the driver of the vehicle performed an acceleration that did not exceed 25% throttle, 50% throttle, or 75% throttle. Alternatively, the vehicular control system may determine that the driver of the vehicle performed an acceleration that did not exceed a longitudinal acceleration of 0.2 g of acceleration, 0.3 g of acceleration, or 0.4 g of acceleration.

In still another example, the vehicular driver monitoring system may increase the driving quality score based on a deceleration of the vehicle that is less than a threshold deceleration value. For example, the vehicular control system may determine that the deceleration that did not exceed a longitudinal deceleration of 0.2 g of deceleration, 0.3 g of deceleration, 0.4 g of deceleration, 0.5 g of deceleration, etc.

In a further example, the vehicular driver monitoring system may increase the driving quality score based on a yaw rate of the vehicle remaining below a threshold yaw rate through the course of a turning maneuver. Optionally, the vehicular control system determines the turning maneuver based on the steering wheel position or the steering system angle of the vehicle. Alternatively, the vehicular control system may increase the driving quality score based on the lateral acceleration of the vehicle remaining below a threshold lateral acceleration through the course of the turning maneuver, such as a lateral acceleration of below 0.3 g, 0.4 g, 0.5 g, etc.

For potential driving maneuvers for which the vehicular driver monitoring system may increase the driving quality score, the owner of the vehicle may determine the threshold values used to determine the driving quality score increases. For example, the owner of the vehicle may, at the parent control mode interface, determine that the vehicular driver monitoring system will increase the driving quality score if the driver of the vehicle performs an acceleration of less than 50% throttle, a deceleration of less than 0.3 g, and/or a turning maneuver of less than 0.5 g. In another example, the owner of the vehicle may, at the parent control mode interface, determine that the vehicular driver monitoring system will increase the driving quality score if the driver of the vehicle performs an acceleration of less than 35% throttle, a deceleration of less than 0.5 g, and/or a turning maneuver of less than 0.4 g.

Optionally, the owner of the vehicle determines whether a particular category of driving maneuver will be considered by the vehicular driver monitoring system in determining the driving quality score. For example, the owner may determine that the vehicular driver monitoring system will determine the driving quality score based on the driver's acceleration and deceleration of the vehicle but not based on rapid turning maneuvers of the vehicle. In another example, the owner may determine that the vehicular driver monitoring system will determine the driving quality score based on the driver's deceleration of the vehicle and rapid turning maneuvers but not based on the driver's acceleration of the vehicle. The owner may determine any combination of driving maneuvers that the vehicular driver monitoring system will consider in determining the driving quality score.

At the end of a driving cycle, the vehicular driver monitoring system may display to the driver the driving quality score at the instrument cluster and/or the display of the vehicle. The vehicular driver monitoring system may provide information regarding driving conditions, maneuvers, or events that occurred during the driving cycle. Optionally, the vehicular driver monitoring system displays information regarding the driver's past driving cycle information or compares the driver's performance in past driving cycles with the driver's performance in the current driving cycle. Similarly, at the end of the driving cycle, the parent control mode may display the driving quality score at the owner's user device (e.g., via the mobile phone application). The driving quality score may be expressed as a number, a percentage, a letter grade, color coding, etc., and/or any combination thereof. The parent control mode may provide the owner with information regarding driving conditions, maneuvers, or events that occur during the driving cycle. Optionally, the parent control mode displays information regarding the driver's past driving cycle information or compares the driver's performance in past driving cycles with the driver's performance in the current driving cycle.

In one example, the vehicular driver monitoring system may restrict functions of the vehicle based on the driver's current and/or historical and/or average driving quality score. For example, the vehicular driver monitoring system may restrict a top speed of the vehicle for the driver when the driver's driving quality score is below a threshold value. Alternatively, the vehicular driver monitoring system may restrict functions of the vehicle based on an erratic driving maneuver performed by the driver. For example, the vehicular driver monitoring system may restrict a top speed of the vehicle for the driver responsive to the driver exceeding the traffic speed limit. Optionally, the vehicular driver monitoring system may restrict a function of the vehicle related to an erratic driving maneuver performed by the driver. For example, the vehicular driver monitoring system may restrict the maximum acceleration rate of the vehicle responsive to determining that the driver performed a rapid acceleration.

The vehicular driver monitoring system may monitor the cabin of the vehicle to identify or classify the driver of the vehicle as a restricted driver. For example, the vehicular driver monitoring system may determine the age or identity of a driver of the vehicle based on facial identification using the interior-viewing camera 28, a key fob associated with the driver, a mobile device associated with the driver, and/or a driver account associated with the driver. The vehicular driver monitoring system, upon determining that the driver is a restricted driver, prevents the driver from certain functions of the vehicle, such as activating a driving mode of the vehicle (e.g., a sport mode), infotainment restrictions, speed restrictions, etc. The vehicular driver monitoring system may be selectively operable in a parent control mode, in which the owner, such as a parent of the restricted driver, may enable parent control mode via a parent control mode interface. By determining whether the driver is a restricted driver, the vehicular driver monitoring system enables the vehicle to seamlessly transition between normal, unrestricted operation of the vehicle and the parent control mode in examples where the vehicle is operated by a plurality of drivers having different ages and levels of driving experience.

The vehicular driver monitoring system, when operating in the parent control mode, may maintain a driving quality score for the driver. The driving quality score may reflect driver attentiveness and safety of driving performance of the driver. At the end of a driving cycle, the vehicular driver monitoring system may display to the driver the driving quality score at the instrument cluster, the display of the vehicle, and/or the user device of the owner. The determined driving quality score allows the owner to monitor and track driving performance of the driver, and provides the driver with information regarding driving quality that the driver may use to improve their driving quality in subsequent drive cycles. The vehicular driver monitoring system may restrict functions of the vehicle based on the driving quality score of the driver and/or based on an erratic driving maneuver performed by the driver. Restricting functions of the vehicle based on the driving quality score allows the owner to protect the driver from dangerous operation of the vehicle without direct, in-person supervision. In sum, the vehicular driver monitoring system improves safety of the vehicle for restricted drivers and provides the restricted driver or an owner of the vehicle with information that the restricted driver may use to improve their driving quality.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward / rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405, 120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739;

US-2020-0320320; US-2020-0202151; US-2020-0143560; US-2019-0210615; US-2018-0231976; US-2018-0222414; US-2017-0274906; US-2017-0217367; US-2016-0209647;

US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or PCT application Ser. Nos. PCT/US25/38021, filed Jul. 17, 2025 (Attorney Docket DON01 FP5398WO) and PCT/US25/27206, filed May 1, 2025 (Attorney Docket DON01 FP5372WO), and/or International Publication No. WO 2023/220222, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driver monitoring system, the vehicular driver monitoring system comprising:
a sensor disposed at a vehicle equipped with the vehicular driver monitoring system, wherein the sensor senses exterior of the equipped vehicle, and wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor, and wherein the data processor is operable to process sensor data captured by the sensor and transferred to the ECU;
wherein the vehicular driver monitoring system is operable to determine whether a driver of the vehicle is a restricted driver;
wherein the vehicular driver monitoring system, responsive to determining that the driver is a restricted driver, enables a restricted driver mode;
wherein the vehicular driver monitoring system, while the restricted driver is driving the vehicle and while the vehicular driver monitoring system is operating in the restricted driver mode, and at least in part via processing at the ECU of captured sensor data, determines whether the restricted driver performs at least one driving event of a plurality of predefined driving events; and
wherein the vehicular driver monitoring system, while operating in the restricted driver mode, determines a driving quality score of the restricted driver based at least in part on the determined at least one driving event.

2. The vehicular driver monitoring system of claim 1, further comprising a camera disposed within an interior cabin of the equipped vehicle and viewing the driver, and wherein the vehicular driver monitoring system determines whether the driver of the vehicle is a restricted driver at least in part via processing at the ECU of image data captured by the camera.

3. The vehicular driving monitoring system of claim 2, wherein the vehicular driver monitoring system determines an age of the driver at least in part via processing at the ECU of image data captured by the camera, and wherein the vehicular driver monitoring system determines that the driver is a restricted driver based at least in part on the determined age of the driver.

4. The vehicular driver monitoring system of claim 2, wherein the vehicular driver monitoring system, at least in part via processing at the ECU of image data captured by the camera, determines whether the driver is distracted.

5. The vehicular driver monitoring system of claim 4, wherein the vehicular driver monitoring system determines whether the driver is distracted based on determining whether the driver is drowsy.

6. The vehicular driver monitoring system of claim 1, wherein the vehicular driver monitoring system determines whether the driver of the vehicle is a restricted driver based at least in part on determining age of the driver.

7. The vehicular driver monitoring system of claim 1, wherein the plurality of predefined driving events comprises at least one selected from the group consisting of (i) a rapid acceleration of the vehicle, (ii) a rapid deceleration of the vehicle and (iii) an erratic steering input of the driver.

8. The vehicular driver monitoring system of claim 1, wherein the sensor comprises a forward-viewing camera that views at least forward of the vehicle, and wherein the plurality of predefined driving events comprises a lane change without activating a turn signal of the vehicle.

9. The vehicular driver monitoring system of claim 1, wherein the sensor senses at least forward of the vehicle, and wherein the plurality of predefined driving events comprises following a leading vehicle in front of the vehicle at an unsafe following distance.

10. The vehicular driver monitoring system of claim 1, wherein the sensor comprises a forward-viewing camera that views at least forward of the vehicle, and wherein the plurality of predefined driving events comprises the vehicle at least partially crossing a lane boundary of a traffic lane.

11. The vehicular driver monitoring system of claim 1, wherein the vehicular driver monitoring system, while operating in the restricted driving mode, restricts a maximum speed of the vehicle.

12. The vehicular driver monitoring system of claim 1, wherein the vehicular driver monitoring system displays at a display of the vehicle the driving quality score.

13. The vehicular driving monitoring system of claim 12, wherein the vehicular driver monitoring system displays the driving quality score responsive to completion of a driving cycle.

14. The vehicular driver monitoring system of claim 1, wherein the vehicular driver monitoring system communicates the driving quality score to a user device.

15. The vehicular driver monitoring system of claim 1, wherein the vehicular driver monitoring system, responsive to determining that the driver is a restricted driver, restricts a driving mode of the vehicle.

16. A vehicular driver monitoring system, the vehicular driver monitoring system comprising:
a sensor disposed at a vehicle equipped with the vehicular driver monitoring system, wherein the sensor senses exterior of the equipped vehicle, and wherein the sensor is operable to capture sensor data;
a camera disposed within an interior cabin of the equipped vehicle and viewing the driver, and wherein the camera is operable to capture image data;
an electronic control unit (ECU) comprising electronic circuitry and associated software;
wherein sensor data captured by the sensor is transferred to the ECU, and wherein image data captured by the camera is transferred to the ECU;
wherein the electronic circuitry of the ECU comprises at least one data processor, and wherein the at least one data processor is operable to (i) process sensor data captured by the sensor and transferred to the ECU (ii) process image data captured by the camera and transferred to the ECU;
wherein the vehicular driver monitoring system is operable to determine whether a driver of the vehicle is a restricted driver based at least in part via processing at the ECU of image data captured by the camera;
wherein the vehicular driver monitoring system, responsive to determining that the driver is a restricted driver, enables a restricted driver mode;
wherein the vehicular driver monitoring system, while the restricted driver is driving the vehicle and while the vehicular driver monitoring system is operating in the restricted driver mode, and at least in part via processing at the ECU of captured sensor data, determines whether the restricted driver performs at least one driving event of a plurality of predefined driving events;
wherein the vehicular driver monitoring system, while operating in the restricted driver mode, determines a driving quality score of the restricted driver based at least in part on the determined at least one driving event; and
wherein the vehicular driver monitoring system communicates the driving quality score to a user device.

17. The vehicular driver monitoring system of claim 16, wherein the vehicular driver monitoring system, at least in part via processing at the ECU of image data captured by the camera, determines whether the driver is distracted.

18. The vehicular driver monitoring system of claim 16, wherein the vehicular driver monitoring system, while operating in the restricted driving mode, restricts a maximum speed of the vehicle.

19. A vehicular driver monitoring system, the vehicular driver monitoring system comprising:
a sensor disposed at a vehicle equipped with the vehicular driver monitoring system, wherein the sensor senses exterior of the equipped vehicle, and wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor, and wherein the data processor is operable to process sensor data captured by the sensor and transferred to the ECU;
wherein the vehicular driver monitoring system is operable to determine whether a driver of the vehicle is a restricted driver based at least in part on determining age of the driver;
wherein the vehicular driver monitoring system, responsive to determining that the driver is a restricted driver, enables a restricted driver mode;
wherein the vehicular driver monitoring system, while the restricted driver is driving the vehicle and while the vehicular driver monitoring system is operating in the restricted driver mode, and at least in part via processing at the ECU of captured sensor data, determines whether the restricted driver performs at least one driving event of a plurality of predefined driving events, and wherein the predefined driving events comprise at least one selected from the group consisting of (i) a rapid acceleration of the vehicle, (ii) a rapid deceleration of the vehicle and (iii) an erratic steering input of the restricted driver; and
wherein the vehicular driver monitoring system, while operating in the restricted driver mode, determines a driving quality score of the restricted driver based at least in part on the determined at least one driving event.

20. The vehicular driver monitoring system of claim 19, wherein the sensor comprises a forward-viewing camera that views at least forward of the vehicle, and wherein the plurality of predefined driving events further comprises at least one selected from the group consisting of (i) a lane change without activating a turn signal of the vehicle and (ii) the vehicle at least partially crossing a lane boundary of a traffic lane.
